(19) United States
(12) Patent Application Publication
(10) Pub. No.: US 2026/0177683 A1
(43) Pub. Date: Jun. 25, 2026

(54) SYSTEM AND METHOD FOR DERIVING CUMULATIVE POSITION-BASED TRACKING HEADING USING POINT DATA

(71) Applicant: HYUNDAI MOBIS CO., LTD., Seoul (KR)

(72) Inventor: Jong Min LEE, Yongin-si (KR)

(73) Assignee: HYUNDAI MOBIS CO., LTD., Seoul (KR)

(21) Appl. No.: 19/417,550

(22) Filed: Dec. 12, 2025

(30) Foreign Application Priority Data
Dec. 19, 2024 (KR) 10-2024-0190936

(51) Int. Cl. G01S 13/42

(52) U.S. Cl. CPC G01S 13/42

(57) ABSTRACT

A system for deriving a cumulative position-based tracking heading using point data, including a center point-based heading candidate extraction module configured to receive previous track information and track position information, continuously and cumulatively store track center points, and calculate a plurality of heading candidates using the stored center points, and a minimum error heading agent module configured to calculate errors of each of the plurality of heading candidates calculated by the center point-based heading candidate extraction module and select a heading candidate with the smallest error. Accordingly, error indicators can be improved quantitatively and qualitatively, and in particular, the quantitative improvement of about 61% compared to the conventional method can be achieved.

### CROSS REFERENCE TO RELATED APPLICATION

The present application claims priority to Korean Patent Application No. 10-2024-0190936, filed on Dec. 19, 2024, the entire contents of which is incorporated herein for all purposes by this reference.

### BACKGROUND

### Technical Field

The present disclosure relates to a tracking technology that derives a direction of an object based on radar point data.

### Description of the Related Art

A tracking technology identifies a state (e.g., speed, position, heading, or the like) of a target by continuously and repeatedly measuring and predicting a state of an object in three-dimensional space. In this case, point data is used to repeatedly measure and predict a state of the track to derive heading values close to the correct value.

However, due to the physical characteristics of radar, problems such as the instability of attribute values (e.g., position, speed, angle, and the like) of the point data, an error in distinguishing between moving and stationary point data, and the like are present.

In this case, since the state of the track is tracked using point data including small and large amplitude noise, the resulting track includes noise. Accordingly, when heading is derived using data including such noise, there are limitations such as errors from the correct value.

### SUMMARY

The present disclosure has been made in efforts to solve the above problems and is directed to providing a method of using a track value including noise but using a position (i.e., a center point) of a track rather than the conventional use of a speed value of the track to achieve improved robustness in terms of stability. That is, the position of the track is used to derive a plurality of heading candidates (up to 10) in each stage, and the heading candidate closest to the correct value may then be selected. In this way, such a methodology for deriving up to 10 heading candidates is a novel feature of the present disclosure.

Accordingly, the present disclosure is directed to improving quantitative heading indicators, which can be used in mass production to assist, for example, a rear cross-traffic collision warning (RCCW) function of radars mounted on side and rear surfaces of a vehicle. These quantitative indicators include heading accuracy, such as a mean error (Mean), a root mean square error (RMSE), a mean absolute error (MAE), etc.

The present disclosure is also directed to improving qualitative evaluations based on the experience of an evaluation team.

Objects of the present disclosure are not limited to the above objects, and other objects will be able to be clearly understood by those skilled in the art based on the following description.

According to an embodiment of the present disclosure, there is provided a system to derive a cumulative position-based tracking heading utilizing point data, including a center point-based heading candidate extraction module configured to receive previous track information and track position information, continuously and cumulatively store center points of a track, and calculate a plurality of heading candidates utilizing the stored center points, and a minimum error heading agent module configured to calculate errors of each of the plurality of heading candidates calculated by the center point-based heading candidate extraction module and select a heading candidate with the smallest error.

According to another embodiment of the present disclosure, there is provided a method of deriving a cumulative position-based tracking heading utilizing point data, which is performed by a computer, including receiving, by a center point-based heading candidate extraction module, previous track information and track position information, continuously and cumulatively storing, by the center point-based heading candidate extraction module, center points of a track based on the received previous track information and the received track position information, calculating, by the center point-based heading candidate extraction module, a plurality of heading candidates utilizing the stored center points, calculating, by a minimum error heading agent module, errors of each of the calculated plurality of heading candidates, and selecting, by the minimum error heading agent module, a heading candidate with the smallest error as a final heading.

### BRIEF DESCRIPTION OF THE DRAWINGS

FIG. 1 is a block diagram showing a system for deriving a cumulative position-based tracking heading using point data according to one embodiment of the present disclosure.

FIG. 2 is a view showing pseudocode related to the track center point-based heading candidate derivation used in the system of FIG. 1.

FIG. 3 is a flowchart showing a method of deriving a cumulative position-based tracking heading using point data according to one embodiment of the present disclosure.

FIG. 4 is a graph showing a quantitative difference between a methodology for deriving a track center point-based heading candidate according to one embodiment of the present disclosure and the conventional methodology.

FIG. 5 is a graph showing a quantitative difference between a methodology for deriving a track center point-based heading candidate according to another embodiment of the present disclosure and the conventional methodology.

FIGS. 6A to 6C are each a view showing experimental results demonstrating qualitative differences between a methodology for deriving a track center point-based heading candidate according to various embodiments of the present disclosure and the conventional methodology.

### DETAILED DESCRIPTION

Hereinafter, a system and method for deriving a cumulative position-based tracking heading using point data will be described in detail with reference to the accompanying drawings. Drawings introduced below are provided as examples so that the spirit of the present disclosure can be sufficiently conveyed to those skilled in the art. Accordingly, the present disclosure is not limited to the drawings presented below and may be specified in other forms. In addition, the same reference numerals denote the same components throughout the specification.

In this case, unless otherwise defined, technical and scientific terms used have the meaning commonly understood by those skilled in the art to which the present disclosure pertains, and the descriptions of well-known functions and configurations that may unnecessarily obscure the gist of the present disclosure will be omitted in the following description and the accompanying drawings.

In addition, a system refers to a set of components including devices, mechanisms, and units that are organized and interact regularly to perform necessary functions.

A system and method for deriving a cumulative position-based tracking heading using point data according to one embodiment of the present disclosure relates to a technology for deriving a direction of an object based on radar point data by receiving previous track information and a position of a track, cumulatively storing center points of the track, calculating a plurality of heading candidates based on the stored center points, and selecting a heading candidate with the lowest error among the plurality of generated heading candidates.

To implement this, FIG. 1 is a block diagram showing a system for deriving a cumulative position-based tracking heading using point data according to one embodiment of the present disclosure, and the system for deriving a cumulative position-based tracking heading using point data according to one embodiment of the present disclosure will be described in detail with reference to FIG. 1.

As shown in FIG. 1, the system for deriving a cumulative position-based tracking heading using point data according to one embodiment of the present disclosure preferably includes a center point-based heading candidate extraction module 101 and a minimum error heading agent module 102. Each of these components is preferably individually or integrally incorporated into at least one or more computational processing means including a computer to perform their operations.

Each component will be described in detail below.

First, the center point-based heading candidate extraction module 101 is configured to receive previous track information and track position information, continuously and cumulatively store center points of the track, and calculate a plurality of heading candidates using the stored center points.

According to one embodiment of the present disclosure, when track elapsed time satisfies a first condition, a plurality of heading candidates may be calculated through an atan function using a difference in X-axis coordinates and a difference in Y-axis coordinates of the stored center points of the track. More specifically, center point information is cumulatively stored after the generation of the track, and for example, center point information from stage k-50 to stage k (θₖ₋₅₀ to θₖ)) may be cumulatively stored, two points may be set using various center point values such as a track center point value of stage k-50 or a previous stage, the most recent track center point value, a center point value of stage k, and the like, and a plurality of heading candidates may be calculated through atan(CP_{Ydiff} and CP_{Xdiff}).

According to another embodiment of the present disclosure, when the track elapsed time satisfies a second condition, a plurality of heading candidates may be calculated using a median absolute deviation (MAD) method. In addition, according to still another embodiment of the present disclosure, when the track elapsed time satisfies a third condition, a plurality of heading candidates may be calculated based on the movement of the stored center points for 2 seconds.

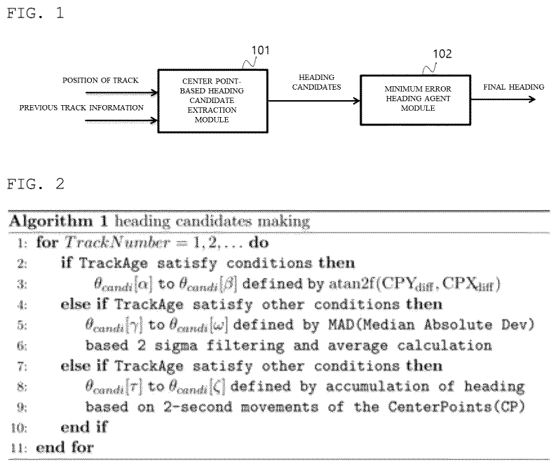

In this regard, FIG. 2 is a view showing pseudocode related to the track center point-based heading candidate derivation used in the system of FIG. 1. That is, FIG. 2 shows pseudocode of an algorithm for generating heading candidates, and the above descriptions of the embodiments of the present disclosure can be determined from the instructions in each line of such an algorithm. That is, when each track satisfies a predetermined condition, it can be determined that heading candidates may be derived using the atan function, MAD-based 2-sigma filtering and average calculation, or heading accumulation based on 2-second movement of the center points as described in the above embodiments.

In this way, one key technical feature of the present disclosure is to derive a plurality of heading candidates (up to 10 heading candidates) based on the center point information of the track using the center point-based heading candidate extraction module 101 of FIG. 1. This is based on a generation position of a track (methodology for the present disclosure) being more stable than a speed of a track (conventional methodology). When error indicators are derived for each scenario according to the methodology for the present disclosure, the mean error (Mean), the root mean square error (RMSE), and the mean absolute error (MAE) are improved in all scenarios, and as will be described below, the average in all scenarios is quantitatively about 61% higher than the performance of the conventional methodology.

Referring back to FIG. 1, the minimum error heading agent module 102 is configured to calculate errors of each of the plurality of heading candidates generated by the center point-based heading candidate extraction module 101 and select the heading candidate with the smallest error. For example, when center point information from stage k-50 to stage k (θₖ₋₅₀ to θₖ)) is cumulatively stored through the center point-based heading candidate extraction module 101, the minimum error heading agent module 102 selects a value with the smallest error in relation to a heading value of stage k-1 as a final heading value. In this way, another key technical feature of the

present disclosure is to select a heading candidate with the smallest difference from the value of the previous stage when ultimately selecting and deriving heading using the minimum error heading agent module 102, thereby minimizing heading shake. In addition, in the present disclosure, by using the minimum error heading agent module 102, a methodology for reducing the use of a memory when constructing ground truth based on most initial candidates being correct during initial generation in consideration of the characteristics of the feature is applied. According to such a methodology of the present disclosure, the number of heading candidates can be reduced to reduce the amount of calculation upon considering mass-produced chips.

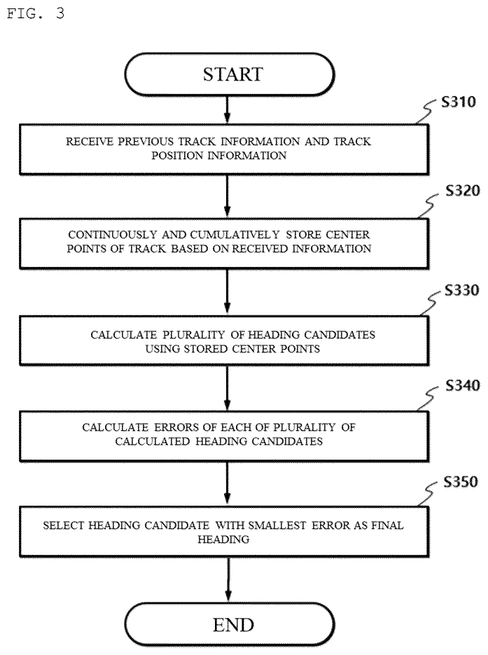

FIG. 3 is a flowchart showing a method of deriving a cumulative position-based tracking heading using point data according to one embodiment of the present disclosure. A method of deriving a cumulative position-based tracking heading using point data according to one embodiment of the present disclosure will be described in detail with reference to FIG. 3.

As shown in FIG. 3, the method of deriving a cumulative position-based tracking heading using point data according to one embodiment of the present disclosure preferably includes receiving previous track information and track position information (S310), continuously and cumulatively storing center points of a track based on the received information (S320), calculating a plurality of heading candidates using the stored center points (S330), calculating errors of each of the plurality of generated heading candidates (S340), and selecting a heading candidate with the smallest error as a final heading (S350). In addition, each operation is performed by a system for deriving a cumulative position-based tracking heading using point data, which is implemented by a computer.

Each operation will be described in detail below.

In the receiving of the previous track information and the track position information (S310), the previous track information and the track position information are received through the center point-based heading candidate extraction module 101.

In the continuously and cumulatively storing of the center points of the track based on the received information (S320), the center points of the track are continuously and cumulatively stored based on the previous track information and track position information received through the center point-based heading candidate extraction module 101. More specifically, center point information is cumulatively stored after the generation of the track, and for example, center point information from stage k-50 to stage k (θₖ₋₅₀ to θₖ) ) may be cumulatively stored, and various center point values such as a track center point value of stage k-50 or a previous stage, the most recent track center point value, a center point value of stage k, and the like may be cumulatively stored.

In the calculating of the plurality of heading candidates using the stored center points (S330), the plurality of heading candidates may be calculated through an atan function using a difference in X-axis coordinates and a difference in Y-axis coordinates of the center points of the track cumulatively stored by the center point-based heading candidate extraction module 101. More specifically, two points may be set using the cumulatively stored center point values, and the plurality of heading candidates (up to 10 candidate groups) may be derived through atan(CP_{Ydiff}, CP_{Xdiff}). In this way, in addition to the method of deriving a plurality of heading candidates using an atan function, a method of deriving a plurality of heading candidates using the MAD method or a plurality of heading candidates based on the movement of the stored center points for 2 seconds may be used.

In the calculating of the errors of each of the plurality of generated heading candidates (S340), the errors are calculated for each of the plurality of heading candidates generated by the center point-based heading candidate extraction module 101 through the minimum error heading agent module 102.

In the selecting of the heading error with the smallest error as the final heading (S350), based on the errors calculated by the minimum error heading agent module 102, the final heading is selected by selecting the heading candidate with the smallest difference from the value of the previous stage upon derivation. For example, when center point information from stage k-50 to stage k(θₖ₋₅₀ to θₖ) is cumulatively stored through the center point-based heading candidate extraction module 101, a value with the smallest error in relation to a final heading value of stage k-1 is selected as a final heading value.

Accordingly, a system and method for deriving a cumulative position-based tracking heading using point data according to one embodiment of the present disclosure have the advantage of overcoming the limitations of the conventional systems for deriving a tracking heading and constructing a system for deriving a tracking heading with quantitatively and qualitatively improved error indicators.

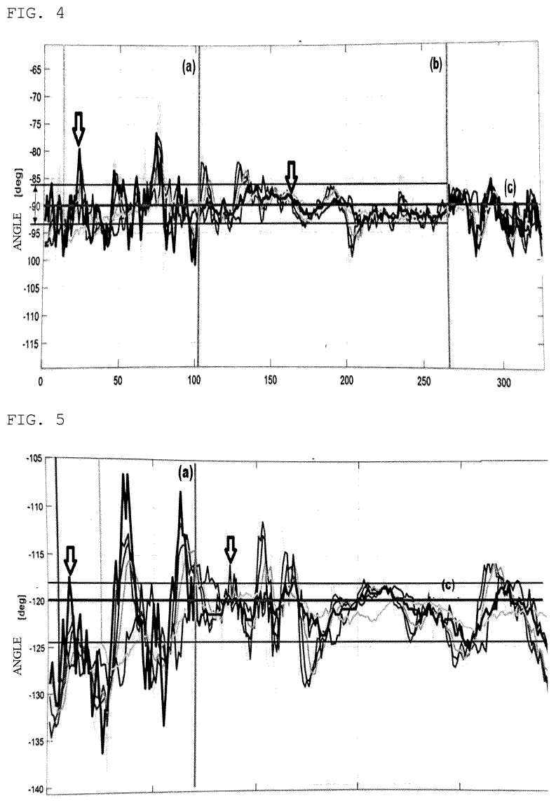

Hereinafter, experimental results demonstrating quantitative and qualitative differences between a methodology for deriving a track center point-based heading candidate proposed in the present disclosure and the conventional methodology will be exemplarily described with reference to FIGS. 4 to 6C.

FIG. 4 is a graph showing a quantitative difference between a methodology for deriving a track center point-based heading candidate according to one embodiment of the present disclosure and the conventional methodology.

Specifically, FIG. 4 shows a situation in which a target vehicle travels at −90 degrees as indicated on the y-axis, and heading normal portions indicated by arrows represent the heading of the target derived based on the speed of the track according to the conventional method. In contrast, heading normal portions, indicated by arrows, in a section from a vertical line indicated by (a) to a vertical line indicated by (b) represent the result derived based on the center points of the track according to the present disclosure. Meanwhile, the remaining lines on the graph, excluding the heading normal lines indicated by arrows, represent heading candidates.

In this way, in FIG. 4, it can be confirmed that the heading normal portions, indicated by arrows, in the section from the vertical line indicated by (a) to the vertical line indicated by (b) represent the result value of a center point-based heading candidate group (i.e., a “methodology of the present disclosure”), and the heading value in this section is very close to a reference that is a horizontal line indicated by (c). In contrast, heading normal portions, indicated by arrows, in the remaining sections excluding the section from the vertical line indicated by (a) to the vertical line indicated by (b) represent a speed-based heading (i.e., a “conventional methodology”), and upper and lower margins of error in this section with respect to the reference that is the horizontal line indicated by (c) are significant. Accordingly, it can be seen that the methodology of the present disclosure quantitatively achieves greater improvement than the conventional methodology. Overall, it can be confirmed that about 61% of the performance is quantitatively improved compared to the conventional methodology.

FIG. 5 is a graph showing a quantitative difference between a methodology for deriving a track center point-based heading candidate according to another embodiment of the present disclosure and the conventional methodology.

Specifically, FIG. 5 shows a situation in which a target vehicle travels at −120 degrees as indicated on the y-axis, and heading normal portions indicated by arrows represent the heading of the target derived based on the speed of the track according to the conventional method. In contrast, heading normal portions, indicated by arrows, in a section from a vertical line indicated by (a) represent the result derived based on the center points of the track according to the present disclosure. Meanwhile, the remaining lines on the graph, excluding the heading normal lines indicated by arrows, represent heading candidates.

In this way, in FIG. 5, it can be confirmed that the heading normal portions, indicated by arrows, in the section from the vertical line indicated by (a) represent the result value of a center point-based heading candidate group (i.e., a “methodology of the present disclosure”), and the heading value in this section is very close to a reference that is a horizontal line indicated by (c). In contrast, heading normal portions, indicated by arrows, in the remaining sections excluding the section from the vertical line indicated by (a) represent a speed-based heading (i.e., a “conventional methodology”), and upper and lower margins of error in this section with respect to the reference that is the horizontal line indicated by (c) are significant. Accordingly, it can be seen that the methodology of the present disclosure quantitatively achieves greater improvement than the conventional methodology. Overall, it can be confirmed that about 61% of the performance is quantitatively improved compared to the conventional methodology.

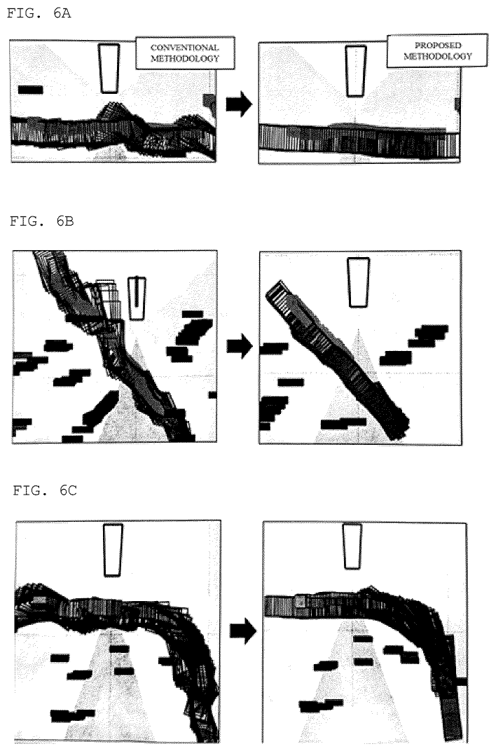

FIGS. 6A to 6C are each a schematic view showing a qualitative difference between a methodology for deriving a track center point-based heading candidate according to various embodiments of the present disclosure and the conventional methodology and shows qualitative results for various scenarios (90 degrees, 120 degrees, 0 to 90 degrees).

Referring to FIGS. 6A to 6C, FIG. 6A shows a qualitative difference between the conventional methodology in the left column and a methodology of the present disclosure in the right column in a scenario in which a target vehicle is traveling at 90 degrees, FIG. 6B shows a qualitative difference between the conventional methodology in the left column and the methodology of the present disclosure in the right column in a scenario in which the target vehicle is traveling at 120 degrees, FIG. 6C shows a qualitative difference between the conventional methodology in the left column and the methodology of the present disclosure in the right column in a scenario in which the target vehicle is traveling at 0 to 90 degrees.

The above method may be provided as a computer program stored on a computer-readable recording medium for execution on a computer. The medium may permanently store a computer-executable program or temporarily store the computer-executable program for execution or download. In addition, the medium may be various recording or storage unit as a single component or multiple hardware components coupled together and is not limited to a medium directly connected to a specific computer system, but may be distributed across a network. Examples of media may include magnetic media such as a hard disk, a floppy disk, and a magnetic tape, optical recording media such as a CD-ROM and a DVD, magneto-optical media such as a floptical disk, and media configured to store program instructions by including a ROM, a RAM, a flash memory, etc. In addition, examples of other media may include recording or storage media managed by app stores that distribute applications, websites that supply or distribute various software, servers, etc.

The methods, operations, or techniques of the present disclosure may be implemented by various units. For example, these techniques may be implemented in hardware, firmware, software, or a combination thereof. Those skilled in the art will understand that various exemplary algorithm operations described in connection with the present disclosure may be implemented in electronic hardware, computer software, or a combination thereof. To clearly describe such interchangeability of hardware and software, various exemplary operations have been described above generally in terms of their functionality. Whether these functions are implemented as hardware or software will vary depending on a specific application and design requirements imposed on the overall system. Those skilled in the art may implement the functions described in various ways for each specific application, but such implementations should not be construed as limiting the scope of the present disclosure.

In hardware implementation, a processing unit used to perform the techniques may be implemented within one or more application-specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, electronic devices, other electronic units designed to perform the functions described herein, computers, or a combination thereof.

Accordingly, various exemplary operations described in connection with the present disclosure may be implemented or performed by any combination of a general-purpose processor, a DSP, an ASIC, an FPGA or other programmable logic device, discrete gate or transistor logic, discrete hardware components, or those designed to perform the functions described herein. The general-purpose processor may be a microprocessor, but alternatively, the processor may be any conventional processor, controller, microcontroller, or state machine. The processor may also be implemented as a combination of computing devices, e.g., a combination of a DSP and a microprocessor, a plurality of microprocessors, one or more microprocessors in conjunction with a DSP core, or any combination thereof.

In firmware and/or software implementations, the techniques may be implemented as instructions stored on a computer-readable medium, such as a RAM, a ROM, a non-volatile random access memory (NVRAM), a programmable read-only memory (PROM), an erasable programmable ROM (EPROM), an electrically erasable PROM (EEPROM), a flash memory, a compact disc (CD), a magnetic or optical data storage device, etc. The instructions may be executable by one or more processors and may cause the processor(s) to perform specific aspects of the functions described herein.

When implemented in software, the operations may be stored on or transmitted over a computer-readable medium as one or more instructions or code. The computer-readable media includes both computer storage media and communication media in addition to any medium that facilitates transfer of a computer program from one place to another. The storage media may be any available media that may be accessed by a computer. As a non-limited example, such computer-readable media may include a RAM, a ROM, an EEPROM, a CD-ROM or other optical disk storage, a magnetic disk storage or other magnetic storage devices, or any other medium that may be used to carry or store desired program code in the form of instructions or data structures and that may be accessed by a computer. In addition, any connection is appropriately referred to as a computer-readable medium.

For example, when the software is transmitted from a website, a server, or other remote source using a coaxial cable, a fiber optic cable, a twisted pair, a digital subscriber line (DSL), or wireless technologies such as infrared, radio, and microwave, the coaxial cable, the fiber optic cable, the twisted pair, the digital subscriber line, or the wireless technologies such as infrared, radio, and microwave are included within the definition of media. The terms “disk” and “disc” as used herein include a CD, a laser disc, an optical disc, a DVD, a floppy disk, and a Blu-ray disc, in which disks typically reproduce data magnetically, while discs reproduce data optically using lasers. The above combinations should also be included within the scope of computer-readable media.

A software module may reside in a RAM, a flash memory, a ROM, an EPROM, an EEPROM, registers, a hard disk, a removable disk, a CD-ROM, or any other form of storage medium known in the art. An exemplary storage medium may be coupled to the processor such that the processor may read information from, and write information to, the storage medium. Alternately, the storage medium may be integrated with the processor. The processor and the storage medium may reside within an ASIC. The ASIC may reside in a user terminal. Alternatively, the processor and the storage medium may reside as discrete components in a user terminal.

While the above embodiments have been described as using aspects of the presently disclosed subject matter in one or more standalone computer systems, the present disclosure is not limited thereto and may be implemented in conjunction with any computing environment, such as a network or distributed computing environment. Furthermore, aspects of the subject matter of the present disclosure may be implemented in multiple processing chips or devices, and the storage may be similarly affected across multiple devices. Such devices may include PCs, network servers, and portable devices.

According to the method of the present disclosure, the following effects can be obtained.

It is possible to quantitatively and qualitatively improve error indicators.

In particular, the error indicators are derived for various scenarios, and in this case, since the mean error (Mean), the root mean square error (RMSE), and the mean absolute error (MAE) can each be improved in all scenarios, as described below, it is possible to achieve quantitative performance improvement of about 61% compared to the conventional method.

Embodiments according to the present disclosure are not limited to those described above, and various alternatives, modifications, and variations may be implemented within the scope that is apparent to those skilled in the art.

What is claimed is:

1. A system to derive a cumulative position-based tracking heading utilizing point data, the system comprising:
a center point-based heading candidate extraction module configured to:
receive previous track information and track position information,
continuously and cumulatively store center points of a track, and
calculate a plurality of heading candidates utilizing the stored center points; and
a minimum error heading agent module configured to:
calculate errors of each of the plurality of heading candidates calculated by the center point-based heading candidate extraction module and
select a heading candidate with the smallest error.

2. The system of claim 1, wherein the center point-based heading candidate extraction module is configured to calculate the plurality of heading candidates through an atan function utilizing a difference in X-axis coordinates and a difference in Y-axis coordinates of the stored center points.

3. The system of claim 1, wherein the center point-based heading candidate extraction module is configured to calculate the plurality of heading candidates utilizing a median absolute deviation (MAD) method.

4. The system of claim 1, wherein the center point-based heading candidate extraction module is configured to calculate the plurality of heading candidates based on movement of the stored center points for 2 seconds.

5. The system of claim 1, wherein a number of heading candidates is up to 10.

6. A method of deriving a cumulative position-based tracking heading utilizing point data, which is performed by each operation by a system to derive the cumulative position-based tracking heading utilizing the point data, which is implemented by a computer, the method comprising:
receiving, by a center point-based heading candidate extraction module, previous track information and track position information;
continuously and cumulatively storing, by the center point-based heading candidate extraction module, center points of a track based on the received previous track information and the received track position information;
calculating, by the center point-based heading candidate extraction module, a plurality of heading candidates utilizing the stored center points;
calculating, by a minimum error heading agent module, errors of each of the calculated plurality of heading candidates; and
selecting, by the minimum error heading agent module, a heading candidate with the smallest error as a final heading.

7. The method of claim 6, wherein the calculating of the plurality of heading candidates is performed through an atan function utilizing a difference in X-axis coordinates and a difference in Y-axis coordinates of the stored center points.

8. The method of claim 6, wherein the calculating of the plurality of heading candidates is performed by utilizing a median absolute deviation (MAD) method.

9. The method of claim 6, wherein the calculating of the plurality of heading candidates is based on movement of the stored center points for 2 seconds.

10. The method of claim 6, wherein a number of heading candidates is up to 10.

11. A non-transitory computer-readable recording medium storing a computer program to execute the method of deriving the cumulative position-based tracking heading utilizing the point data according to claim 6.
